(19) United States
(12) Patent Application Publication
(10) Pub. No.: US 2021/0334334 A1
(43) Pub. Date: Oct. 28, 2021

(54) TWIDDLE FACTOR GENERATING CIRCUIT FOR AN NTT PROCESSOR

(71) Applicant: COMMISSARIAT A L'ENERGIE ATOMIQUE ET AUX ENERGIES ALTERNATIVES, Paris (FR)

(72) Inventors: Joel CATHEBRAS, Palaiseau (FR); Alexandre CARBON, Massy (FR); Renaud SIRDEY, Cernay-La-Ville (FR); Nicolas VENTROUX, Gif-Sur-Yvette (FR)

(73) Assignee: COMMISSARIAT A L'ENERGIE ATOMIQUE ET AUX ENERGIES ALTERNATIVES, Paris (FR)

(21) Appl. No.: 17/259,065

(22) PCT Filed: Jul. 9, 2019
(86) PCT No.: PCT/FR2019/051696

§ 371 Date: Jan. 8, 2021

(30) Foreign Application Priority Data
Jul. 10, 2018 (FR) 1856340

(51) Int. Cl. G06F 17/14

(52) U.S. Cl. CPC G06F 17/142

(57) ABSTRACT

A circuit for generating twiddle factors for an NTT processor. The circuit includes a cache management manager, a modular multipliers bank, and a central controller. The cache management module includes a local controller and a cache memory in which operands are stored for calculating future twiddle factors. The modular multipliers bank includes an interconnection matrix at the input distributing operands on the modular multiplier inputs. The circuit can be configured to minimise the size of the cache memory and/or reduce the latency of the twiddle factor sequence calculation. Finally, the generating circuit may include several calculation management modules sharing the same modular multipliers bank to generate sequences of twiddle factors on several finite fields.

### TECHNICAL FIELD

This invention relates to the field of NTT (Number Theoretic Transform) processors. Its applications are particularly in Euclidean network cryptography, and particularly in homomorphic cryptography.

### STATE OF PRIOR ART

Number Theoretic Transform (or NTT) has been known since the 1970s and has recently been found to be advantageous in cryptographic applications.

It will be recalled that a number theoretic transform is the equivalent of a Fourier transform in a Galois field of characteristic q, GF (q) , the primitive root of unity of a N-th order Fourier transform in □, namely

$${e}^{j \frac{2 π}{N}} ,$$

being replaced by an N-th root of unity of the field GF(q). Thus, N is the smallest non-null integer n such that ψⁿ=1. The number theoretic transform (NTT) of a sequence a=a₀, . . . , a_{N-1} of N elements of GF(q) is defined by a sequence A=A₀, . . . , A_{N-1} such that:

$${A}_{k} = {\sum }_{n = 0}^{N - 1} {a}_{n} {ψ}^{n k} \qquad ( 1 )$$

in which the addition and multiplication operations are those of the field GF(q).

It should be noted that ψ is not necessarily a primitive root of GF(q), in other words its order is not necessarily equal to the order q−1 of the multiplicative group of GF(q) but that the order N of vi is necessarily a divider of q−1.

If N and q are coprime, there is an inverse N⁻¹ in the Galois field GF(q) and the inverse number theoretic transform (Inverse NTT) can be defined by:

$${a}_{n} = {N}^{- 1} {\sum }_{k = 0}^{N - 1} {A}_{k} {ψ}^{- n k} \qquad ( 2 )$$

the inverses ψ^{-nk} existing provided that GF(q) is a field.

By analogy with the Fourier transform, the elements ψ^{nk} and ψ^{-nk} appearing in the expression (1) or (2) are called twiddle factors.

In general, the characteristic q of a field is in the form q=p^{m} wherein p is a prime number and m is a non-null integer. In the following we will consider finite fields GF(q) for which the characteristic is a prime numberp , that are known to be isomorphic to □ₚ=□/p□.

A general presentation of NTT can be found in the paper by J. M. Pollard “The fast Fourier transform in a finite field” published in Mathematics of Computation, vol. 25, No. 114, April 1971, pp. 365-374.

The NTT transform is used in RNS (Residue Number System) arithmetic in the context of Euclidean network cryptography in which it can considerably simplify the multiplication of high order polynomials with large coefficients.

It is known that the multiplication of two polynomials involves a calculation of the convolution of the sequence of coefficients of the first polynomial with the sequence of coefficients of the second polynomial. In using the dual space, in other words after NTT, the multiplication of polynomials then only requires a simple one by one multiplication of the transformed sequences. All that is then necessary is to perform an INTT on the resulting sequence to obtain coefficients of the sequence corresponding to the product of two polynomials.

This acceleration of the polynomial calculation can be applied to an RNS representation of the polynomials. More precisely, if a polynomial

$$f ( x ) = {\sum }_{i = 0}^{N - 1} {α}_{i} {x}^{i}$$

is considered, it can be made to correspond to a set L of polynomials

$${f}^{( ℓ )} ( x ) = {\sum }_{i = 0}^{N - 1} {α}_{i}^{( ℓ )} {x}^{i}$$

wherein [symbol] =αᵢ mod [symbol] and [symbol] , [symbol] =0, . . . , L−1 are coprime (and generally prime) integers, chosen to be relatively small. The set {p₀, . . . , p_{L-1}} is called the RNS base.

This representation of coefficients and consequently the associated polynomial is an immediate application of the Chinese Remainder Theorem (CRT). The CRT(αᵢ)={αᵢ⁽⁰⁾, . . . , αᵢ^{(L-1)}} and CRT(ƒ)={ƒ⁽⁰⁾, . . . , ƒ^{(L-1)}} notation will be used in the following.

Conversely, an RNS representation

$${f}^{( ℓ )} ( x ) = {\sum }_{i = 0}^{N - 1} {α}_{i}^{( ℓ )} {x}^{i} ,$$

[symbol]

=0, . . ., L−1 can be associated with a polynomial ƒ=ICRT{ƒ⁽⁰⁾, . . . , ƒ^{L-1)}} defined by

$$f ( x ) = {\sum }_{i = 0}^{N - 1} {α}_{i} {x}^{i} ,$$

wherein the coefficients αᵢ=ICRT{αᵢ⁽⁰⁾, . . . , αᵢ^{(L-1)}} are given by:

$${α}_{i} = {\sum }_{ℓ = 0}^{L - 1} ( \frac{P}{{p}_{ℓ}} ) ( {( \frac{P}{{p}_{ℓ}} )}^{- 1} \cdot {α}_{i}^{( ℓ )} mod {p}_{ℓ} ) mod P \qquad ( 3 )$$

and wherein

$$P = {\prod }_{ℓ = 0}^{L - 1} {p}_{ℓ}$$

is the product of the prime numbers used for the RNS decomposition of the coefficients.

Thus, the multiplication of two polynomials with degree N,

$$f ( x ) = {\sum }_{i = 0}^{N - 1} {α}_{i} {x}^{i} and$$

$$g ( x ) = {\sum }_{i = 0}^{N - 1} {β}_{i} {x}^{i}$$

can be converted by RNS representation and NTT transform to N.L multiplications of coefficients

$${A}_{k}^{( ℓ )} = {\sum }_{i = 0}^{N - 1} {{α}_{i}^{( ℓ )} ( {ψ}_{ℓ} )}^{ik} and {B}_{k}^{( ℓ )} = {\sum }_{i = 0}^{N - 1} {{β}_{i}^{( ℓ )} ( {ψ}_{ℓ} )}^{ik} ,$$

k=0, . . . , N−1 in dual space wherein ψ_{ƒ} an Nth root of unity of the field [symbol] and [symbol] , [symbol] are elements of Z_{pƒ} obtained by decomposition of the coefficients αᵢ and βᵢ in the RNS base {p₀, . . . , p_{L-1}}. It is then possible to return to the initial space using an inverse transform INTT of each sequence of coefficients [symbol] = [symbol] Bₖ^{(ƒ)}, k=0, . . . , N−1 to obtain the coefficients in an RNS representation

$${γ}_{k}^{( ℓ )} = {N}^{- 1} {\sum }_{i = 0}^{N - 1} {{C}_{k}^{( ℓ )} ( {ψ}_{ℓ} )}^{ik}$$

and then the coefficients of the product polynomial h(x)=ƒ(x)g(x) by ICRT. Given that the degree of h(x) is 2N, polynomials of degree N′=2N (and therefore the N′-th roots of unity) can immediately be considered by zero padding with N zeroes of the N coefficients of the highest degrees of ƒ(x) and g(x). Based on this convention, the same space can be used for the product polynomial and the polynomials ƒ(x) and g(x) to be multiplied.

A detailed description of the application of the NTT transform to the multiplication of polynomials in a CRT representation can be found in the paper by W. Dai et al. entitled “Accelerating NTRU based homomorphic encryption using GPUs” published in Proc. of IEEE High Performance Extreme Computing Conference (HPEC), 2014, 9-11 Sep. 2014.

A polynomial multiplication using an NTT transform of polynomial coefficients represented in an RNS base requires the use of roots of unity [symbol] of finite fields [symbol] and of their powers ( [symbol] )ⁿ, n=0, . . . N−1, both to calculate the NTT transform of the coefficients (in RNS representation) of the polynomials to be multiplied and to calculate the INTT transform of the coefficients (in RNS representation) of the product polynomial in dual space.

A first approach consists of storing twiddle factors ( [symbol] )ⁿ, n=0, . . . , N−1, in memory, for finite fields [symbol] , [symbol] =0, . . . , L−1. However, since the degrees of polynomials are generally very high and cryptoprocessors must be able to operate on a wide variety of finite fields and roots of unity, the required memory size is quite large.

A second approach consists of performing the calculation of twiddle factors on the fly to supply them to the processor that performs the NTT calculation.

One general purpose of this invention is to disclose a circuit for generating twiddle factors for an NTT processor capable of accelerating the cryptographic calculations on a Euclidean network. A more specific purpose of this invention is to disclose a circuit for generating twiddle factors that can adapt itself to the processing rate of an NTT stream processor, while only requiring a small amount of local memory resources and/or only having a short calculation latency.

### PRESENTATION OF THE INVENTION

This invention is defined by a circuit generating twiddle factors on at least one finite field, for an NTT stream processor, said generating circuit being designed to generate at least one sequence of N twiddle factors {ψ⁰, ψ¹, ψ², . . , ψ^{N-1}} wherein ψ is a root of unity in this field, said circuit comprising
at least one cache management module comprising a cache memory and a local controller controlling write and read in the cache memory;
a modular multipliers bank comprising a plurality of W modular multipliers operating in parallel, each modular multiplier performing one multiplication on said field of two operands derived from a word read from the cache memory;
a central controller initialising the cache memory with the G first twiddle factors of the sequence and controlling the cache manager so as, in each calculation cycle of a plurality T=N/W of calculation cycles, to supply a word read from the cache memory to the modular multipliers bank, to write a word into the cache memory at the end of each calculation cycle except for the last of said plurality, comprising the W results output from said modular multipliers, and to provide these W results at the end of each calculation cycle at the output from the generator, as W consecutive twiddle factors of said series.

According to a first embodiment, the bank of W modular multipliers performs the R₀=U₀U₁ mod p; R₁=U₀U₂ mod p; . . . ; R_{W-1}=U₀U_{W} mod p multiplications respectively, wherein U₀U₁, . . . U_{W} is the word read from the cache memory and t U_{w}, w=0, . . . , W are the operands input to the modular multipliers bank and R_{w}, w=0, . . . , W−1 are the W output results from these multipliers.

The cache memory advantageously comprises a first part with size W and a second part with size LatMM+1 wherein LatMM is the latency of the modular multipliers bank, the central controller initialising the content of the first part of the cache memory with ψ¹, ψ², . . . , ψ^{W} and the second part with ψ^{W}, the word read from the cache memory for the first calculation cycle being U₀U₁ . . . U_{W}=ψ^{W}ψ¹ψ² . . . ψ^{W}.

In this case, each time that a twiddle factor calculated by the modular multipliers bank is a multiple of W, an address is incremented in the second part of the cache memory and the twiddle factor is stored at the address thus incremented.

The cache memory may also comprise an address pointer pointing to the address at which the value of U₀ should be read for the next calculation cycle, the values of U₁ . . . U_{W} being read from the first part and the word U₀U₁ . . . U_{W} formed from the concatenation of these values being supplied to the modular multipliers bank for the next calculation cycle.

According to a second embodiment, the bank of W modular multipliers performs the s R₀=U₀U₁ mod p; R₁=U₁U₁ mod p; R₁=U₁U₂ mod p . . . ;

$${R}_{W - 1} = {U}_{\frac{W}{2}} {U}_{\frac{W}{2}}$$

mod p multiplications respectively, wherein

$${U}_{0} {U}_{1} … {U}_{\frac{W}{2}}$$

is the word read from the cache memory and U_{w},

$$w = 0 , … , \frac{W}{2}$$

are the operands input to the modular multipliers bank and R_{w}, w=0, . . . , W=1 are the W output results from these multipliers.

Advantageously, the cache memory is

$$( \frac{N}{W} - 1 ) \frac{W}{2} ,$$

the central controller initialising the content of the cache memory with ψ², ψ³, . . . ,

$${ψ}^{\frac{W}{2}} .$$

In this case, after a word is read in the cache memory to prepare a calculation cycle, the content of this memory is offset by

$$\frac{W}{2}$$

and, at the end of the calculation cycle, the word composed of the output results from the modular multipliers bank is stored after the content thus offset.

Advantageously, regardless of the embodiment, said generating circuit will generate a plurality L of sequences of N twiddle factors { [symbol] } wherein the elements [symbol] , [symbol] =0, . . . , L−1 are the N-th roots of unity in a plurality L of finite fields, said generating circuit comprising:
a plurality L of cache management modules, each cache management module comprising a cache memory and a local controller controlling write and read in the corresponding cache memory;
a modular multipliers bank shared between the different cache management modules;
a central controller initialising in turn the L cache memories with the G first twiddle factors of the sequence { [symbol] }, and controlling each cache manager so as, for each calculation cycle of a plurality T=N/W of calculation cycles, to supply a word read from the cache memory to the modular multipliers bank, to write a word into the cache memory associated with this cache manager at the end of each calculation cycle except for the last of said plurality, comprising the W results output from the modular multipliers bank, and to provide these W results at the end of each calculation cycle at the output from the generator, as a set of W consecutive twiddle factors of said sequence, the sets of W twiddle factors for the L sequences being supplied interleaved.

Each cache management module can be provided at the input to a multiplexer controlled by the central controller, so as to transmit either an initialisation word of the G first twiddle factors of the corresponding sequence, or W results from the modular multipliers bank, to the cache memory associated with the cache management module.

### BRIEF DESCRIPTION OF THE DRAWINGS

Other characteristics and advantages of the invention will become clear after reading a preferred embodiment of the invention, described with reference to the appended figures among which:

FIG. 1 diagrammatically represents a dependencies graph for the generation of twiddle factors;

FIG. 2 diagrammatically represents a first coverage example of the graph in FIG. 1, corresponding to a first strategy for generating twiddle factors;

FIG. 3 diagrammatically represents a second coverage example of the graph in FIG. 1, corresponding to a second strategy for generating twiddle factors;

FIG. 4 diagrammatically represents the general architecture of a twiddle factor generating circuit according to a first embodiment of the invention;

FIG. 5 diagrammatically represents the general architecture of a modular multipliers bank for the generating circuit in FIG. 4;

FIG. 6A diagrammatically represents a first example of a modular multipliers bank;

FIG. 6B illustrates the strategy for generating twiddle factors using the modular multipliers bank in FIG. 6A;

FIG. 6C diagrammatically represents the scheduling of calculations in the twiddle factor generating circuit when the modular multipliers bank is as shown in FIG. 6A;

FIG. 7A diagrammatically represents a second example of a modular multipliers bank;

FIG. 7B illustrates the strategy for generating twiddle factors using the modular multipliers bank in FIG. 7A;

FIG. 7C diagrammatically represents the scheduling of calculations in the twiddle factor generating circuit when the modular multipliers bank is as shown in FIG. 7A;

FIG. 8 diagrammatically represents the general architecture of a twiddle factor generating circuit according to a second embodiment of the invention;

FIG. 9 diagrammatically represents the scheduling of calculations in the twiddle factor generating circuit in FIG. 8.

### DETAILED PRESENTATION OF PARTICULAR EMBODIMENTS

We will start by considering the generation of twiddle factors in a finite field, that will be considered as Zₚ in which p is a prime number, within an isomorphism, and therefore without loss of generality. If ψ is the N-th root of unity in this field, the problem in question is to generate all the elements {ψⁿ|n=0, . . . , N−1}. These twiddle factors will be supplied to an NTT processor, or equivalently, to an INTT processor, at a predetermined rate.

The generation of twiddle factors can be represented using an oriented graph, called a dependencies graph, in which each node represents a power ψⁿ, a power ψⁿ being associated with one node for each method of calculating it from preceding nodes. Each node of the graph, apart from the node representing the root ψ, is assumed to have an input degree (number of edges leading to this node) less than or equal to 2, in other words each twiddle factor ψⁿ is generated from not more than 2 preceding factors.

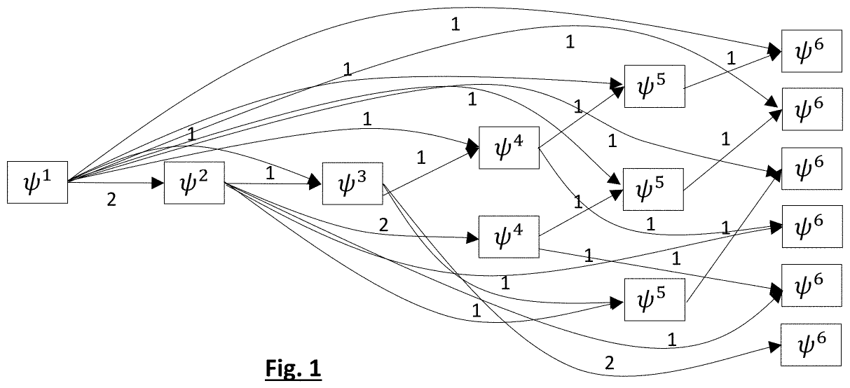

FIG. 1 illustrates the dependencies graph for the generation of the first six elements in the series {ψⁿ|n=0, . . . , N−1}. The edges identify the parents of each node. Thus, for example, ψ⁶ can be calculated in six different ways depending on which parents are chosen. The weight associated with each edge is the weight of the parent factor. Thus, a node may be the end of two edges with weight 1 (for example ψ⁶ is calculated as the product ψ¹ψ⁵ or ψ²ψ₄ from two distinct parent nodes) or a single edge with weight 2 (for example ψ⁶ is calculated as the product ψ³ψ³ from a single parent node).

The dependencies graph may be scanned so as to minimise local memory requirements or the calculation latency for the generation of twiddle factors.

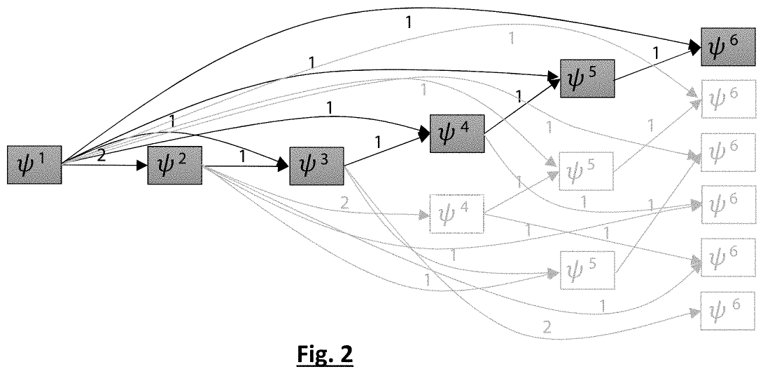

FIG. 2 represents a first example of a coverage of the graph in FIG. 1, aiming to minimise memory resource needs.

Coverage of the graph in question means a sub-graph in which the parents of each node are the nodes of this sub-graph, and such that each twiddle factor in the series {ψⁿ|n=0, . . . , N−1} is represented by a node on this sub-graph.

Coverage of the graph illustrated in FIG. 1 corresponds to minimisation of resources in local memory for generation of the series {ψⁿ|n=0, . . . , N−1}. In this case, all that is necessary is to keep the root of unity 1 in memory and the twiddle factors are calculated making use of the following recurrence relation:

Rₒ=1

R₁=ψ

Rₙ₊₁RₙR₁, ∀n∈[1, N−1] (4)

However, it will be noted that the calculation latency that arises with this generation strategy is high in that it is necessary to wait for n recurrence steps before the twiddle factor ψⁿ is obtained.

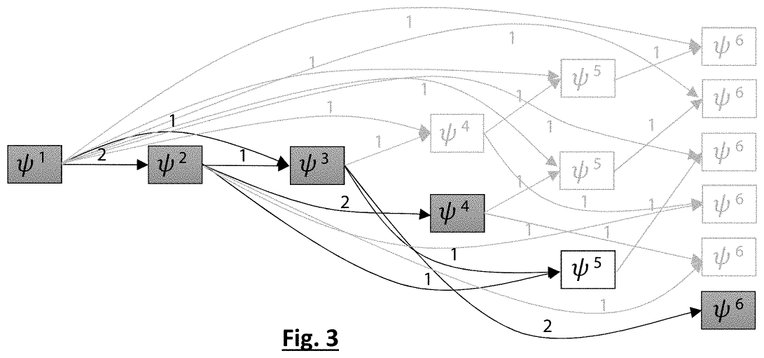

FIG. 3 represents a second example of a coverage of the graph in FIG. 1, aiming to minimise the calculation latency.

Thus for example, as illustrated in FIG. 3, it is no longer necessary to wait for the generation of ψ⁵ to calculate ψ⁶. A twiddle factor is generated as soon as twiddle factors of the parent nodes are available.

On the other hand, this generation strategy involves the need to be able to store previously generated twiddle factors. For example, it will be necessary to store ψ³ for the future generation of ψ⁵ and ψ⁶ while calculating ψ⁴=ψ²ψ².

The twiddle factor generation strategy corresponding to this graph coverage can be represented by the following recurrence relation:

$$\begin{matrix}{R}_{0} = 1 ; {R}_{1} = ψ & ( 5 ) \\ \text{and} ∀ n ∈ [ 1 , \frac{N}{2} - 1 ] , \begin{matrix}{R}_{2 n} = {R}_{n} {R}_{n} ; \\ {R}_{2 n + 1} = {R}_{n + 1} {R}_{n}\end{matrix} & \end{matrix}$$

In the preceding examples, it has been assumed that the single twiddle factor ψ is available at the beginning. However, in general, there may be G initial twiddle factors available corresponding to the G first elements of the series, namely {ψ¹, . . . , ψ^{G}}.

In the following, we will also assume that the twiddle factor generating circuit generates the series {ψⁿ|n=0, . . . , N−1} over several cycles, the totality of twiddle factors in the series being generated after T=N/W cycles. In each cycle, the NTT processor performs a radix operation (similar to a radix operation in an FFT) on the W input data.

Finally, in order to simplify the presentation, we will assume that G=W, in other words that the number of initial twiddle factors is the same as the width of the data path, and that W and N are powers of 2.

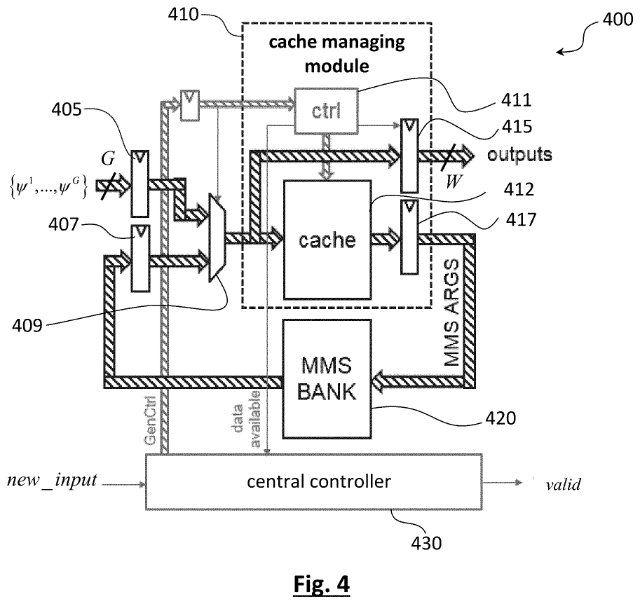

FIG. 4 diagrammatically represents the general architecture of a twiddle factor generating circuit according to a first embodiment of the invention.

The generating circuit 400 comprises essentially a cache management manager, 410, a modular multipliers bank, 420, and a central controller, 430.

The cache management module has a local controller, 411, a cache memory 412, an output register 415 to provide W twiddle factors in each cycle and an intermediate output register 417 to provide operands output from the cache memory to the modular multipliers bank at the beginning of each cycle. In general, the function of the cache management module is to clock calculations in the series of twiddle factors depending on the selected coverage strategy of the dependencies graph.

During each cycle, the modular multipliers bank receives operands from the cache management module, namely powers ψⁱ stored in the cache memory, and deduces twiddle factors to be supplied for the current cycle from these values. The twiddle factors thus calculated are supplied to the output register 415 and stored in the cache memory. More precisely, the output results from the modular multipliers are supplied to an intermediate input register 407 before being transmitted to the output register 415 and stored in the cache memory 412.

At the beginning of each sequence of T cycles, the G initial twiddle factors {ψ¹, . . . , ψ^{G}} are supplied to the cache management module 410 through an input register 405. The outputs from the input register and the intermediate input register are multiplexed by the multiplexer 409. This multiplexer, controlled by the central controller 430, transmits the initial twiddle factors to the input of the cache management module during the initialisation of a series of T cycles, then the twiddle factors calculated by the modular multipliers bank to the input of the cache management module at the beginning of each of the T−1 next cycles in the series.

The central controller 430 generates a set GenCtrl of control signals composed of the signals new_set, compute and new_data that control the local cache management module controller. The first control signal, new_set, is used to initialise the calculation manager every T cycles and in particular to reset internal counters of the local controller to zero. It also orders the input multiplexer 409 to transmit the initial twiddle factors {ψ¹, . . . , ψ^{G}} received on the input register 405, to the cache management module. The second control signal, compute, orders the cache management module to perform a calculation cycle, in other words to read the operands in the cache memory and to provide them to the modular multipliers bank 420. The third control signal, new_data, informs the local controller that it must take account of the new twiddle factors calculated by the modular multipliers bank. In return, the local controller informs the central controller when it is ready to perform a new calculation making use of availability information data_available. More precisely, this availability information takes on a high logical value when the cache 412 contains twiddle factors that can be used to calculate the next elements in the series, and the central controller has not yet used the signal compute to order these calculations.

The local controller comprises a first counter counting the number of twiddle factors already generated, a second counter counting the number of twiddle factors stored in the cache memory and a third counter counting the number of calculation cycles requested by the central controller since the last initialisation (in other words since the beginning of the series). The local controller comprises a combinational logic circuit receiving control signals from the central controller and supplying control signals for the above-mentioned counters, availability information, the cache memory control signals and the output register control signal. The output register control signal is used to output the W last twiddle factors generated on the output bus.

The central controller is composed essentially of a combinational logic circuit and an offset register. The depth of the offset register is determined as a function of the latency of the modular multipliers bank (to make the calculations) and the latency of the cache management module (to update the output register and its intermediate output register). The offset register advances in each clock cycle.

The central controller receives a signal new input on its input informing it that a new set of initial twiddle factors {ψ′¹, . . . ,V′^{G}} is available on the input bus for a new series of calculations of twiddle factors {ψ′ⁿ|n=0, . . . , N−1} in which ψ′ is a new root of unity in Zₚ. As seen above, the central controller also receives the availability information data_available from the cache management module. Starting from the signals new_input and data_available, the combinational logic circuit of the central controller generates the control signals new_set, compute and new_data for the next calculation cycle. The combinational logic circuit also updates the offset register input at the beginning of each calculation cycle. A signal valid is generated at the output from the offset register, in other words after taking account of each of the latencies of the modular multipliers bank, indicating that a set of W twiddle factors is available on the output bus.

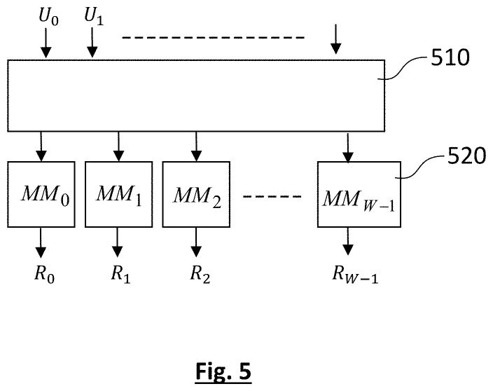

FIG. 5 diagrammatically represents the general architecture of a modular multipliers bank for the generating circuit in FIG. 4.

It comprises an interconnection matrix, 510, designed to receive operands output from the cache memory and to distribute them on the inputs of W modular multipliers operating in parallel, 520, designated by MM₀, . . . , MM_{W-1}, each modular multiplier MM_{w} forming a modulo multiplication p of its two input operands to supply the result R_{w}.

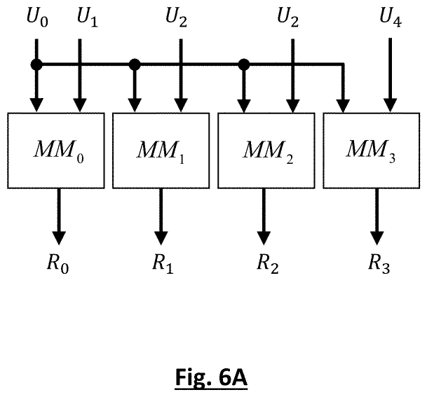

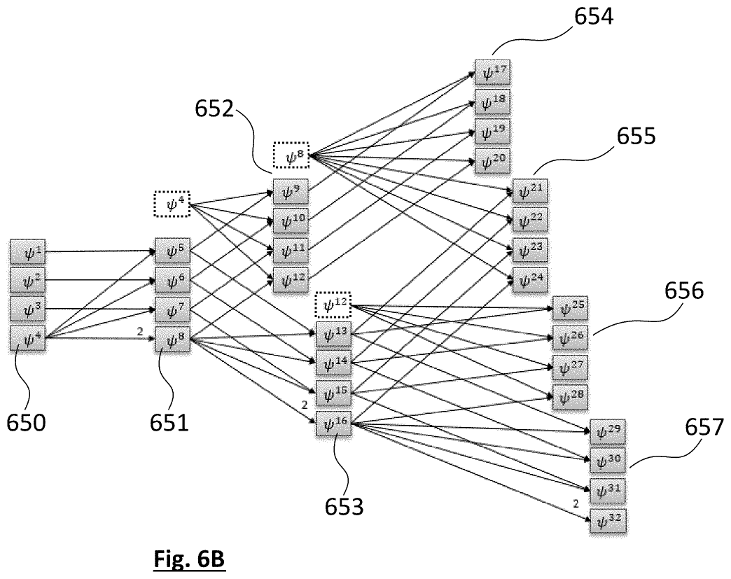

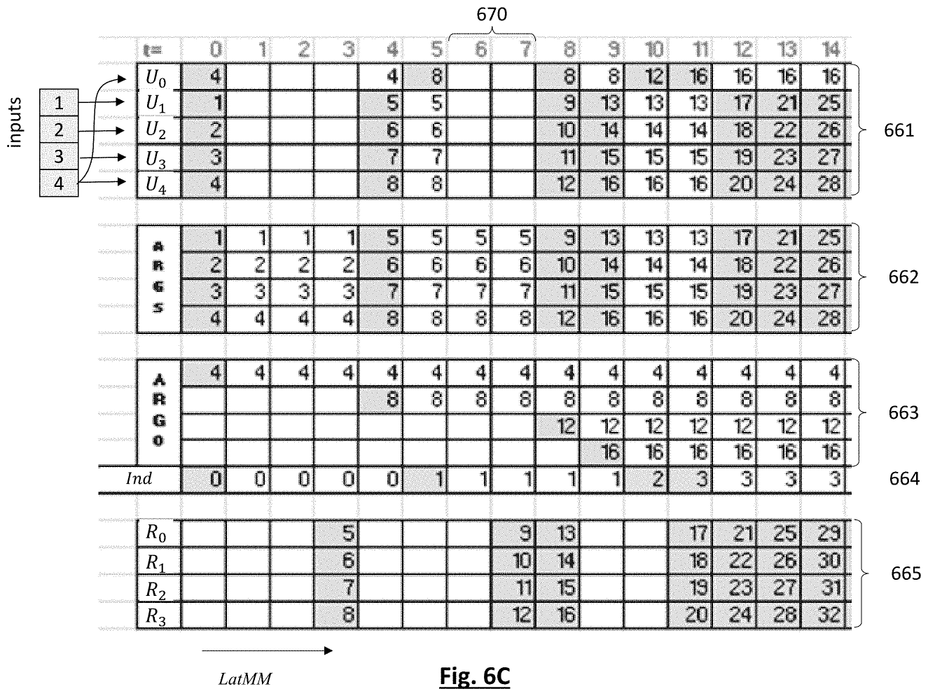

FIG. 6A diagrammatically represents a first example of a modular multipliers bank.

This example implementation corresponds to a strategy to minimise the size of the cache memory of the cache management module. The interconnection matrix receives W+1 operands and distributes them on the 2 W inputs of the modular multipliers.

In this example G=W=4 and the operands are denoted U₀, . . . , U₄. The modular multipliers MM₀, . . . , MM₃ perform the following calculations:

R₀=U₀U₁ mod p

R₁=U₀U₂ mod p

R₂=U₀U₃ mod p

R₃=U₀U₄ mod p (6)

In general, according to the strategy to minimise the size of the cache, the modular multipliers bank performs the following operations:

R₀=U₀U₁ mod p

R₁=U₀U₂ mod p . . .

R_{W-1}=U₀U_{W} mod p (7)

FIG. 6B illustrates the strategy for generating twiddle factors using the multipliers bank in FIG. 6A for N=32 and a latency of the modular multipliers bank LatMM=3. Remember that in the example in FIG. 6A, G=W=4.

The outputs from the modular multipliers bank or more precisely the output data from the multiplexer 409 are represented as 650 to 657 (in which 650 corresponds to the initialisation state), for 8 successive calculation cycles. The values appearing in the boxes shown in discontinuous lines are values stored in a second part of the cache memory as explained below.

FIG. 6C diagrammatically represents the scheduling of calculations in the twiddle factor generating circuit when the modular multipliers bank is implemented as in FIG. 6A.

661 represents the operands U₀, . . . , U₄ at the input to the modular multipliers bank; 662 and 663 represent a first part and a second part of the cache memory denoted AGRS and AGRO; 665 represents the output results R₀, . . . , R₃ from the modular multipliers bank.

The size of AGRS is equal to W, the size of AGR0 is equal to LatMM+1 (in the example illustrated it is assumed that the modular multipliers bank has a latency LatMM of 3 clock cycles).

The memory locations of AGRS are denoted C₀, . . . , C₃, the memory locations of AGRO are denoted B₀, . . . , B₃. The most recent results output by R₀, . . . , R₃ are stored in AGRS in C₀, . . . , C₃, and the twiddle factors called the reserve factors defined as the LatMM+1 first twiddle factors ψⁱ in the series, in which i is a multiple of W, are stored in AGRO in B₀, . . . , B₃.

For reasons of clarity, the exponents i have been represented instead of the corresponding twiddle factors ψⁱ.

The operands U₁, . . . , U₄ are read in AGRS memory locations C₀, . . . , C₃ and the operand U₀ is read from AGR0 at the address given by the index Ind in 664. This index is generated by the local controller of the cache management module.

The calculation of the series of twiddle factors {ψ¹, . . . , ψ³²} begins with the reception of initial values {ψ¹, . . , ψ⁴}. These initial values are stored (at time t₀) in cache memory at locations C₀, . . . , C₃. Since the initial value ψ⁴ is a reserve twiddle factor, it is also stored in B₀. The values stored in cache memory are supplied to the modular multipliers bank with Uₒ=(B₀)=ψ⁴, U₁=(C₀)=ψ¹, U₂=(C₁)=ψ², U₃=(C₂)=ψ³, U₄=(C₃)=ψ⁴ .

The results appearing at the output from the modular multipliers bank after LatMM clock cycles (at time t₃) are then R₀=ψ⁵, R₁=ψ⁶, R₂=ψ⁷, R_{3 l =ψ}⁸. These results are then stored (at time t₄) at locations C₀, . . . , C₃ in AGRS and since ψ⁸ is a reserve twiddle factor it is stored at location B₁. The operands U₁, . . . , U₄ are read in AGRS memory locations C₀, . . . , C₃and the operand U₀ is read from AGRO at the address given by the index Ind, namely B₁, namely: U₀=(B₁)=ψ⁸, U₁=(C₀)=ψ⁵, U₂=(C₁)=ψ⁶, U₃=(C₂)=ψ⁷, U₄=(C₃)=ψ⁸.

The results appearing at the output from the modular multipliers bank after LatMM clock cycles (at time t₈) are then R₀=ψ⁹, R₁=ψ¹⁰, R₂=ψ¹¹, R₃=ψ¹². The process continues until the last series of W twiddle factors is generated in t₁₄, namely R₀=ψ²⁹, R₁=ψ³⁰, R₂=ψ³¹, R₃=ψ³².

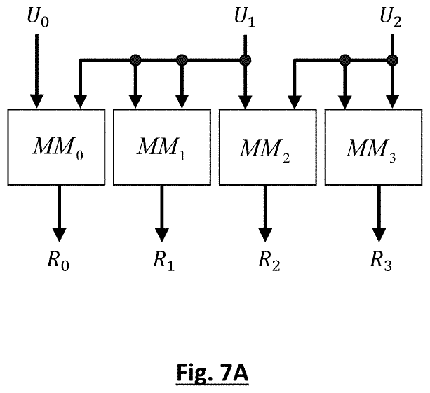

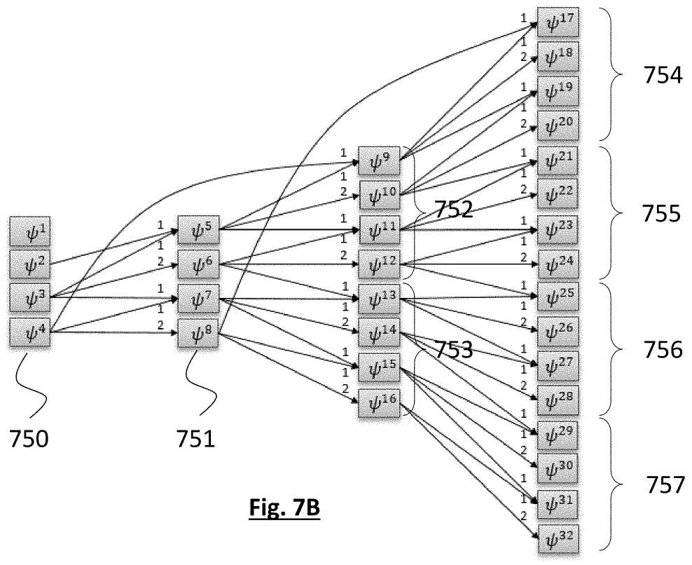

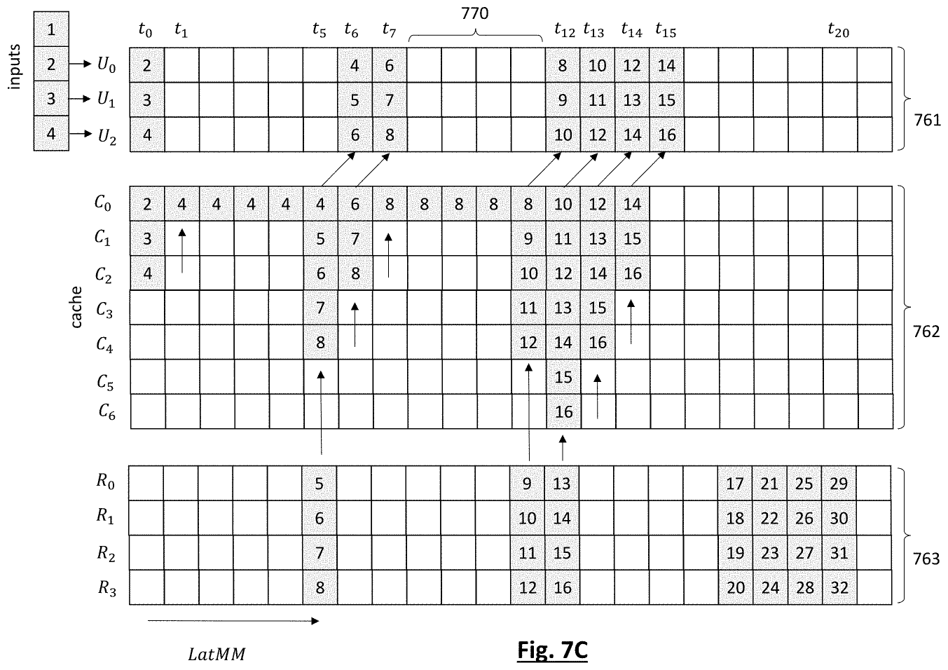

FIG. 7A diagrammatically represents a second example of a modular multipliers bank.

This implementation example corresponds to an earlier generation of twiddle factors.

In this case, the interconnection matrix receives

$$\frac{W}{2} + 1$$

operands and distributes them on the 2W inputs of the modular multipliers.

In this example G=W=4 and the operands are denoted U₀, U₁, U₂. The modular multipliers MM₀, . . . , MM₃ perform the following calculations:

R₀=U₀U₁ mod p

R₁=U₁U₁ mod p

R₂=U₁U₂ mod p

R₃=U₂U₂ mod p (8)

In general, according to the strategy to minimise the calculation latency, the modular multipliers bank performs the following operations:

$${R}_{0} = {U}_{0} {U}_{1 } mo d p \\ {R}_{1} = {U}_{1} {U}_{1} mod p \\ {R}_{1} = {U}_{1} {U}_{2 } mod p … \\ {R}_{W - 1} = {U}_{\frac{W}{2}} {U}_{\frac{W}{2}} mod p \qquad ( 9 )$$

FIG. 7B illustrates the strategy for generating twiddle factors using the modular multipliers bank in FIG. 7A.

The outputs from the modular multipliers bank or more precisely the output data from the multiplexer 409 are represented as 750 to 757 (in which 750 corresponds to the initialisation state), for 8 successive calculation cycles.

FIG. 7C diagrammatically represents the schedule of the calculations in the twiddle factor generating circuit when the modular multipliers bank is implemented as in FIG. 7A.

761 represents the operands U₀,U₁,U₂ at the input to the modular multipliers bank; 763 represents the locations of the cache memory C₀, . . . , C₅; 765 represents the output results R₀, . . . , R₃ from the modular multipliers bank. It is assumed herein that the latency of the modular multipliers bank is LatMM=5 clock cycles.

As before, the calculation of the series of twiddle factors {ψ¹, . . . , ψ³²} begins with the reception of initial values {ψ¹, . . . , ψ⁴}. The initial values {ψ², . . . , ψ⁴} are stored (at time t₀) in cache memory at locations C₀, . . . , C₂.

The values stored in cache memory are supplied to the modular multipliers bank with U₀=(C₀))=ψ², U₁=(C₁)=ψ³, U₂=(C₂)=ψ⁴. Once these values have been supplied, the memory content is offset by 2 locations at the next clock tick (at time t₁). Thus, in this case, after the offset, only the value ψ⁴ remains stored at location C₀.

The results appearing at the output from the modular multipliers bank after LatMM (at time t₅) are then R₀=ψ⁵, R₁=ψ⁶, R₂=ω⁷, R₃=ψ⁸. The results R₀, . . . , R₃ are stored after C₀ at locations C₁, . . . , C₄ for preparation of the following calculations.

The values stored at C₀, C₁, C₂ are then supplied (at time t₇) to the modular multipliers bank, namely: U₀=(C₀)=ψ⁴, U₁=(C₁)=ψ⁵, U₂=(C₂)=ψ⁶. Once these values have been supplied, the content of the cache memory is once again offset by two locations. Thus, all that remains stored in the cache are the values ψ⁶, ψ⁷, ψ⁸.

At time t₈, the values stored in the cache memory are supplied to the modular multipliers bank with U₀=(C₀))=ψ⁶, U₁=(C₁)=ψ⁷, U₂=(C₂)=ψ⁸, and the content of the cache memory is then offset again by two locations; only the value ψ⁸ remains stored in C₀.

The results appearing at the output from the modular multipliers bank at time t₁₂ are then R₀=ψ⁹, R₁=ψ¹⁰, R₂=ψ¹¹, R₃=ψ¹². The results R₀, . . . , R₃ are stored after C₀ at locations C₁, . . . , C₄ for preparation of the following calculations. At time t₁₃, the values stored are supplied to the modular multipliers bank with U₀=(C₀)=ψ⁸, U₁=(C₁))=ψ⁹, U₂=(C₂)=ψ¹⁰.

The process continues using the same logic until time t₂₀ at which the modular multipliers bank supplies the last W twiddle factors {ψ²⁹, . . . , ψ³²}.

In this case, all other things being equal, the^{'} calculation of the complete series {ψ¹, . . . , ψ³²} is as fast in the first example as in the second. In the first example, if the latency were LatMM=5, the calculation would also have been terminated at time t₂₀. However, in general with a coverage of the dependency graph of the type in FIG. 7B, the calculation of the complete series of twiddle factors is faster (more precisely the rate

$$\frac{N}{W} )$$

than for a coverage of the type in FIG. 6B.

The size of the cache memory in the second example is

$$\frac{N - W}{2} .$$

In each of the

$$\frac{N}{W} - 1$$

calculations, W twiddle factors are written and

$$\frac{W}{2}$$

are eliminated, the memory size necessary to avoid overwriting the useful data is

$$( \frac{N}{W} - 1 ) \frac{W}{2} .$$

For high values of the degreeN, it is checked that the memory size required in the first example (W+LatMM+1) is much less than the size required in the second example.

In the two implementation examples described above, it can be noted that there are waiting times (or “bubbles”, for example at 670 or 770) in the supply to the modular multipliers bank, due to the latency LatMM and dependency relations to be respected in the dependencies graph. The result is a discontinuous generation of twiddle factors, at least for the first elements in the series.

These waiting times can be used in a second embodiment of the invention to calculate twiddle factors on a plurality of finite fields [symbol] , [symbol] =0, . . . , L−1 in a context of NTT transforms in RNS arithmetic.

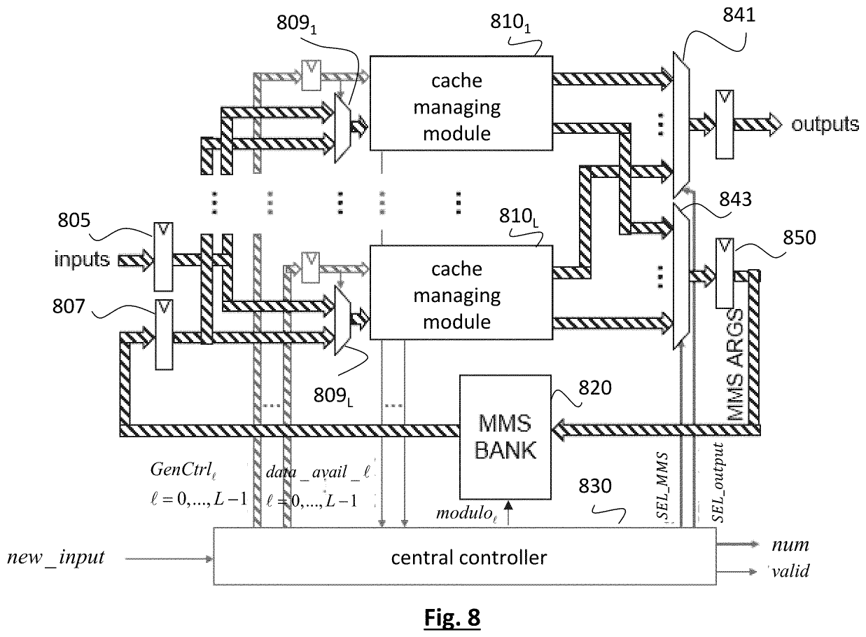

FIG. 8 diagrammatically represents the general architecture of a twiddle factor generating circuit according to a second embodiment of the invention.

Unlike the first embodiment, in this case the twiddle factor generating circuit comprises a plurality L of cache management modules 810₀, . . . , 810_{L-1}, each having the structure of the cache management module 410. Each of these modules is associated with a finite field [symbol] and has its own local controller and its cache memory. There is an output bus and an intermediate output bus at the output from each of these modules.

The output buses from the different cache management modules are multiplexed by a first output multiplexer 841 controlled by the central controller through a command SEL_output. Similarly, the intermediate output buses from the different cache management modules are multiplexed by a second output multiplexer 842 controlled by the central controller through a command SEL_MMS.

As in the first embodiment, the twiddle factor generating circuit comprises a modular multipliers bank, 820, and a central controller, 830.

The modular multipliers bank 820 is supplied with data through a common register, 850, at the output from the second output multiplexer. It also receives a signal modulo from the central controller informing the modular multipliers about which field Z_{Pƒ} the multiplications have to be made in.

The initial twiddle factors { [symbol] } are supplied in turn to the calculation management modules, 810_{ƒ}, [symbol] =0, . . . , L−1, through the input register 805. The twiddle factors calculated by the modular multipliers bank are supplied through the intermediate input register 807. The outputs from the input register and the intermediate input register are each distributed to all the calculation management modules. Each cache management module, 810_{ƒ} has an associated multiplexer at its input, 809_{ƒ}, controlled by the central controller 830. Thus, the central controller can inform one of the calculation management modules 810_{ƒ} that it should import the initial twiddle factors { [symbol] } or the twiddle factors calculated by the modular multipliers bank.

The central controller comprises a combinational logic circuit and two offset registers that it can use to generate control signals for the L cache management modules, 81 [symbol] , ƒ=0, . . . ,L−1, and to propagate: the output multiplexer control signal 841, SEL_MMS, the intermediate output multiplexer control signal 843, SEL_output, and the validity signals, valid, with the source, num, described below. More precisely, the central controller receives a signal new_input on its input informing it that a new set of initial twiddle factors is available on the input bus for a new series of twiddle factor calculations. It also receives availability information data_available_ƒ, ƒ=0, . . . , L−1, from the calculation management modules, informing it of which modules are available for a new calculation. Starting from the signals new_input and data_available_ƒ, ƒ=0, . . . , L−1, the combinational logic circuit of the central controller generates the set GenCtrl_{ƒ} of control signals new_set_ [symbol] , compute_ƒ et new_data_ƒ, ƒ=0, . . . , L−1 for the next calculation cycle. As we will see later, the central controller can give lower priority to calculations that have made the most progress. In other words, as the more a series { [symbol] } advances, the lower its assigned priority and the later the corresponding signal compute_ƒ will be updated.

At the output, the central controller supplies the control signals for the first and second output multiplexers 841, 843. When a set of W twiddle factors is available on the output bus, the central controller indicates this by means of the signal valid and uses the signal num to specify the field [symbol] to which this set belongs.

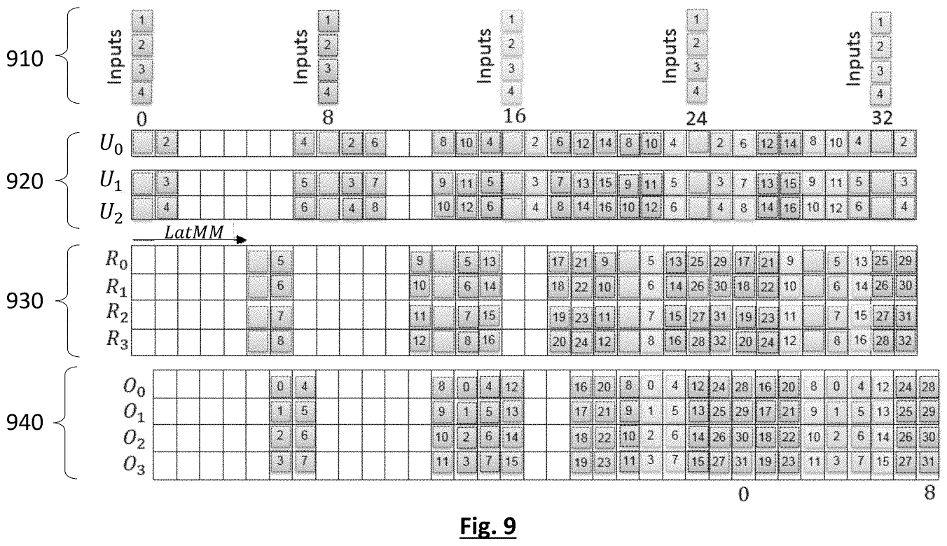

FIG. 9 diagrammatically represents the scheduling of calculations in the twiddle factor generating circuit in FIG. 8.

Without prejudice to generalisation, the second embodiment will be described for an earliest calculation strategy. However, an expert in the subject will understand that it can also be applicable when it is required to minimise the memory size of the cache.

In the scheduling example illustrated in FIG. 9, it is assumed that N=32, G=W=4 and therefore T=8. In other words, a new set of initial values { [symbol] } is supplied to the twiddle factors generator every T=8 cycles. It is assumed herein that the latency of the modular multipliers bank is LatMM=5 clock cycles as shown in FIG. 7C.

910 represents the sets of initial values; 920 represents the operands U₀, U₁, U₂ at the input to the modular multipliers bank; 930 represents the results R₀, . . . , R₃ at the output from the modular multipliers bank and 940 represents the output from the first output multiplexer. Boxes shown in grey correspond to the insertion of a new set of initial values.

For simplification reasons, the content of cache memories has not been represented. It is observed that modular multipliers are saturated with data after the arrival of several sets (in this case 3). Scheduling of the different series respects the flow rate of T=8 calculation cycles between the initial sets, at the cost of a slight additional latency for generation of the first series (4 additional clock cycles corresponding to the insertion of the next 2 series of initial values).

Finally, the elements of the different series are supplied at the output as soon as they are generated. The signal num can be used to distinguish them. In particular, this signal can be used by an NTT stream processor to separate NTTs on different fields.

1. A circuit generating twiddle factors (400) on at least one finite field (Zₚ), for an NTT stream processor, said generating circuit being designed to generate at least one sequence of N twiddle factors {ψ⁰, ψ¹, ψ², . . . , ψ^{N-1}} wherein ψ is a root of unity in this field, wherein:
at least one cache management module comprising a cache memory and a local controller controlling write and read in the cache memory;
a modular multipliers bank comprising a plurality of W modular multipliers operating in parallel, each modular multiplier performing one multiplication on said field of two operands derived from a word read from the cache memory;
a central controller initialising the cache memory with the G first twiddle factors of the sequence and controlling the cache manager so as, in each calculation cycle of a plurality T=N/W of calculation cycles, to supply a word read from the cache memory to the modular multipliers bank, to write a word into the cache memory at the end of each calculation cycle except for the last of said plurality, comprising the W results output from said modular multipliers, and to provide these W results at the end of each calculation cycle at the output from the generator, as W consecutive twiddle factors of said series.

2. The circuit generating twiddle factors according to claim 1, wherein the bank of W modular multipliers performs the R₀=U₀U₁ mod p; R₁=U₀U₂ mod p; . . . , ; R_{W-1}=U₀U_{W} mod p multiplications respectively, wherein U₀U₁ . . . U_{W} is the word read from the cache memory and U_{w}, w=0, . . . , W are the operands input to the modular multipliers bank and R_{w}, w=0, . . . , W−1 are the W output results from these multipliers.

3. The circuit generating twiddle factors according to claim 2, wherein the cache memory comprises a first part with size W and a second part with size LatMM+1 wherein LatMM is the latency of the modular multipliers bank, the central controller initialising the content of the first part of the cache memory with ψ¹, ψ², . . . , ψ^{W} and the second part with ψ^{W}, the word read from the cache memory for the first calculation cycle being U₀U₁ . . . U_{W}=ψ^{W}ψ¹ψ² . . . ψ^{W}.

4. The circuit generating twiddle factors according to claim 3, wherein, each time that a twiddle factor calculated by the modular multipliers bank is a multiple of W, an address is incremented in the second part of the cache memory and the twiddle factor is stored at the address thus incremented.

5. The circuit generating twiddle factors according to claim 4, wherein the cache memory also comprises an address pointer (Ind) pointing to the address at which the value of U₀ should be read for the next calculation cycle, the values of U₁ . . . U_{W} being read from the first part and the word U₀U₁ . . . U_{W} formed from the concatenation of these values being supplied to the modular multipliers bank for the next calculation cycle.

6. The circuit generating twiddle factors according to claim 1, wherein the bank of W modular multipliers performs the R₀=U₀U₁ mod p; R₁=U₁U₁ mod p; R₁=U₁U₂ mod p . . . ;
$${R}_{W - 1} = {U}_{\frac{W}{2}} {U}_{\frac{W}{2}}$$
mop p multiplications respectively, wherein
$${U}_{0} {U}_{1} … {U}_{\frac{W}{2}}$$
is the wont react from the cache memory and U_{w}, w=0, . . . ,
$$\frac{W}{2}$$
are the operands input to the modular multipliers bank and R_{w}, w=0, . . . , W−1 are the W output results from these multipliers.

7. The circuit generating twiddle factors according to claim 6, wherein the size of the cache memory is
$$( \frac{N}{W} - 1 ) \frac{W}{2} ,$$
the central controller initialising the content of the cache memory with ψ², ψ³, . . ,
$${ψ}^{\frac{W}{2}} .$$

8. The circuit generating twiddle factors according to claim 7, wherein, after a word is read in the cache memory to prepare a calculation cycle, the content of this memory is offset by
$$\frac{W}{2}$$
and, at the end of the calculation cycle, the word composed of the output results from the modular multipliers bank is stored after the content thus offset.

9. The circuit generating twiddle factors according to claim 1, wherein said generating circuit will generate a plurality L of sequences of N twiddle factors {ψ₁⁰, ψ₁¹, ψ₁², . . . , ψ₁^{N}} wherein the elements ψ₁, I=0, . . . , L−1 are the Nth roots of unity in a plurality L of finite fields (Z_{P1}, I=0, . . . , L−1), said generating circuit comprising:
a plurality L of cache management modules each cache management module 810 comprising a cache memory and a local controller controlling write and read in the corresponding cache memory;
a modular multipliers bank shared between the different cache management modules;
a central controller initialising in turn the L cache memories with the G first twiddle factors of the sequence {ψ₁⁰, ψ₁², ψ₁², . . . , ψ₁^{N}}, and controlling each cache manager so as, for each calculation cycle of a plurality T=N/W of calculation cycles, to supply a word read from the cache memory to the modular multipliers bank, to write a word into the cache memory associated with this cache manager at the end of each calculation cycle except for the last of said plurality, comprising the W results output from the modular multipliers bank, and to provide these W results at the end of each calculation cycle at the output from the generator, as a set of W consecutive twiddle factors of said sequence, the sets of W twiddle factors for the L sequences being supplied interlaced.

10. The circuit generating twiddle factors according to claim 7, wherein each cache management module is provided at the input to a multiplexer controlled by the central controller, so as to transmit either an initialisation word of the G first twiddle factors of the corresponding sequence, or W results from the modular multipliers bank, to the cache memory associated with the cache management module.
